(19) United States
(12) Patent Application Publication
(10) Pub. No.: US 2023/0084639 A1
(43) Pub. Date: Mar. 16, 2023

(54) System and Method for Engineering Drawing Extrapolation and Feature Automation

(71) Applicant: Vectra Automation, Inc., Dover, DE (US)

(72) Inventors: Vinod Kettay, Cary, NC (US); Pradeep Kanth, Chennai (IN); Amitabh Mukherjee, Kennett Square, PA (US); K.T.N. Varma, Andhra Pradesh (IN); K. Shanmugam Sundaram, Chennai (IN); Anish Mukherjee, Jharkhand (IN); Soundar Rajan, Chennai (IN); S. Naga Reddy, Bangalore (IN); Ryan Perry, Midland, MI (US); Akhil Menon, Kochi Kerala (IN); Raj Ramesh, Mississauga (CA)

(73) Assignee: Vectra Automation, Inc., Dover, DE (US)

(21) Appl. No.: 17/940,445

(22) Filed: Sep. 8, 2022

Related U.S. Application Data
(60) Provisional application No. 63/242,139, filed on Sep. 9, 2021.

(51) Int. Cl. G06F 30/12; G06N 5/02

(52) U.S. Cl. CPC G06F 30/12; G06N 5/022

(57) ABSTRACT

The present invention is a system and method for 3D engineering drawing extrapolation and automation incorporating Machine Learning (ML). The instant innovation receives a 3D computer model of a part to be manufactured, and automatically breaks the model into labelled surfaces capable of being attributed, assigned and represented by 2D drawings. One or more sub-processes receives data defining attributes of the 2D drawings and performs calculations to pre-determine drill-hole locations on a machine-ready part. The system then determines if there are unintended gaps, interferences, or other irregularities resident thereupon. The system creates a list of any irregularities and returns a punch list to a human user for correction. The system utilizes Amazon Web Services (AWS) to both perform data extracting and flattening of the 3D model and to select optimally-sized machine stock and optimize its orientation in relation to the manufacturing machine head.

### COPYRIGHT NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever.

### CROSS REFERENCE TO RELATED APPLICATIONS

This application claims the benefit of priority to U.S. Provisional Application No. 63/242,139, filed 9 Sep. 2021, and entitled “System and Method for Engineering Drawing Extrapolation and Feature Automation” which is incorporated by reference herein in its entirety.

### BACKGROUND

The history of modern industrialization can be illustrated through the steady evolution of the draftsman's art. The draftsman's reduction of three-dimensional space to a two-dimensional representation with datums, dimensions, and other notes which enable manufacturing of a part/assembly is a triumph of man's intellect over spatial constraints. Man-made tools to aid in manufacturing ease, such as 3D modeling computer programs, introduce their own challenges and opportunities for technical evolution. Some 3D modeling systems permit static extrapolation of 2D images. These 2D images typically reflect a birds-eye view of the front, top, and side of parts to be machine-manufactured. Machinists utilize such images to manually select manufacturing stock, determine the position of such stock in the workspace, and to affect manufactured alterations to the stock.

### BRIEF DESCRIPTION OF THE DRAWINGS

Certain illustrative embodiments illustrating organization and method of operation, together with objects and advantages may be best understood by reference to the detailed description that follows taken in conjunction with the accompanying drawings in which:

FIG. 1 is an overview of pre-drafting (and post 3D CAD modeling) process modules consistent with certain embodiments of the present invention.

FIG. 2 is a view of a sub-process for 2D data extraction consistent with certain embodiments of the present invention.

FIG. 3 is a view of a sub-process for core engine operation consistent with certain embodiments of the present invention.

FIG. 4 is a view of a sub-process for automated 2D drawing generation consistent with certain embodiments of the present invention.

FIG. 5 is a view of a sub-process for 2D drawing quality control consistent with certain embodiments of the present invention.

FIG. 6 is an overview of the data processing workflow consistent with certain embodiments of the present invention.

FIG. 7 is a process flow diagram for selection of isometric views consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language).

Reference throughout this document to “one embodiment”, “certain embodiments”, “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

However, unless specifically stated otherwise as apparent from the following discussion, it is appreciated that throughout the description, discussions utilizing; terms such as “processing” or “computing” or “calculating” or “determining” or “displaying” or “analyzing” or “deducing” or the like, refer to the action and processes of a computer system. or similar electronic computing device (such as a specific computing machine), that manipulates and transforms data represented as physical (electronic) quantities within the computer system memories or registers or other such information storage, transmission or display devices.

Reference herein to “Vectra” refers to Vectra Automation, Inc., a Delaware C-Corp., the entity that owns, manages, oversees, and/or implements the invention herein described.

Reference herein to “Auto2D” refers to a trademark, registered trademark, and/or trade name for one or embodiments of the instant innovation.

Certain aspects of the embodiments include process steps and instructions described herein. It should be noted that the process steps and instructions of the embodiments can be embodied in software, firmware or hardware, and when embodied in software, could be downloaded to reside on and be operated from different platforms used by a variety of operating systems. The embodiments can also be in a computer program product which can be executed on a computing system.

The embodiments also relate to an apparatus for performing the operations herein. This apparatus may be specially constructed for the purposes, e.g., a specific computer, or it may comprise a computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Memory can include any of the above and/or other devices that can store information/data/programs and can be transient or non-transient medium, where a non-transient or non-transitory medium can include memory/storage that stores information for more than a minimal duration. Furthermore, the computers referred to in the specification may include a single processor or may be architectures employing multiple processor designs for increased computing capability.

The processes and displays presented herein are not inherently related to any particular computer or other apparatus. Various systems may also be used with programs in accordance with the teachings herein, or it may prove convenient to construct more specialized apparatus to perform the method steps. The structure for a variety of these systems will appear from the description herein. In addition, the embodiments are not described with reference to any particular programming language. It will be appreciated that a variety of programming languages may be used to implement the teachings of the embodiments as described herein, and any references herein to specific languages are provided for disclosure of enablement and best mode.

Although translation of 3D Engineering Drawings is a necessary step in the preparation of a three-dimensional workpiece model into instructions for manufacturing, no existing system permits for the automation of all aspects of the process. Machine Learning further optimizes steps in the process. Thus, there is a need for a system and method for 3D engineering drawing extrapolation and automation incorporating Machine Learning (ML).

In an embodiment, the instant innovation is utilized in the field of manufacturing of tangible, manufactured parts and assemblies. The instant innovation receives a three-dimensional (3D) computer model of a part to be manufactured, and breaks down a 3D model of the part into labelled surfaces capable of being attributed, assigned and represented by two-dimensional (2D) engineering drawings. Next, a sub-process of the instant innovation receives data that define attributes of the 2D drawings and performs calculations to determine the one or more physical locations on a manufacturing-ready part at which one or more holes will be drilled. The sub-process then determines if there are one or more instances of unintended gaps, interferences, hole alignment and other irregularities resident within the 3D CAD models. The sub-process creates a list of any such irregularities and returns a punch list to a human user for manual correction.

In an embodiment, the instant innovation utilizes a server bank such as, by way of non-limiting example, Amazon Web Services (AWS) to perform certain data extraction and flattening of the 3D model. The instant innovation utilizes AWS to select optimally sized standard machine stock from a database and optimize orientation of the machine stock in relation to the operative head of the milling machine, lathe, CNC router, or other manufacturing machine.

In an embodiment, the instant innovation includes an algorithm that recognizes manufacturing features on every component and assigns an appropriate dimension and/or drawing entity to each of them. In a non-limiting example, the algorithm performs computations upon the geometric data extracted from 3D Computer-Aided Drafting (CAD) models and attributes assigned to them. A standardized data extraction strategy may be employed across all CAD platforms, including, by way of non-limiting examples, solid-body-based modelling platforms like Siemens NX and/or Dassault SolidWorks, or parametric-surface modelling platforms such as Dassault CATIA and/or Autodesk Inventor. Such a standardization is an essential ingredient in the formulation of a CAD-agnostic core algorithm as used in the instant innovation.

In an embodiment, the algorithm analyzes each manufacturing sub-assembly in the context of the main tool assembly, and a component hierarchy is deduced from the assembly-level data and mounting planes of every component are inferred. This part of the algorithm involves traversing through the assembly tree spanning all its branches and inter-connections in an efficient and time-optimized manner. The resulting inter-component mounting analysis is utilized within the instant innovation to determine the datum faces and related “start” faces on each component that are in turn needed to dimension various manufacturing features. Certain manufacturing components may be made of multiple sub-components welded together to form a “weld assembly.” The presence of such sub-components requires additional determination of start faces in relation to a prospective or retrospective welding operation. Assembly-level analysis concludes with the determination of a “primary drawing view orientation,” in which determination datum surfaces are necessarily captured and the dimensions of important features are aligned with the local coordinate system.

In an embodiment, the algorithm of the instant innovation identifies features related to various manufacturing operations on a given component through a combination of “logical flows,” involving attributes assigned to the 3D model, and “geometric signatures,” which are signatures specific to such features. To determine these logical flows and geometric signatures, geometric data extracted from the 3D model is processed and staged into a form that is amenable to analysis in various perspectives of the component. By way of non-limiting example, each feature may be associated with one or more surfaces on the component. When more surfaces are involved, topological considerations specific to the feature in question are envisaged in the algorithm design. In general, every surface is analyzed both individually and in the context of a larger topological network of surfaces. This inclusive approach of feature recognition is customizable to variety of manufacturing operations. In an embodiment, such customization may be based upon said staging, analysis, and topological form.

In an embodiment, the algorithm of the instant innovation uses deterministic logic augmented with heuristic pattern-match algorithms backed by machine learning. By employing such pairing, the instant innovation may auto-generate from component drawings and interpret as graph patterns motifs comprising one or more features. The instant innovation may simultaneously or sequentially infer dimensioning information.

In an embodiment, component data resulting from the generation of an ever-growing repository of component assemblies is constantly collected. The instant innovation uses heuristic-model-learning from this dataset to recognize patterns in a production environment and complement the feature determination process in the core algorithm. The learning models are envisaged to cover a wide variety of components in diverse assembling environments. Such pattern recognition allows for faster improvements in the feature-recognition process of the instant innovation. By way of non-limiting example, the instant innovation may employ machine learning to pull one or more pre-calculated assemblies from an assembly library, to analyze the pre-calculated assemblies for near-pattern matches to a new part to be modelled, and to use a suitable pre-calculated assembly as a customizable template for the new part.

In an embodiment, the instant innovation has at its core an algorithm that recognizes manufactured features on every component in an assembly and associates appropriate dimension entities to each of them. The algorithm essentially relies on the geometric data extracted from 3D CAD models and attributes assigned to them. The geometric data consists of granular level details of the CAD model in the form of faces, and the face positions and orientations in a uniform coordinate system. Boundaries of the faces are represented in the form of edges with well-defined curvature. Such a standardized data extraction strategy is employed across all CAD platforms, including but not limited to parametric solid modelling (on platforms such as, by way of non-limiting example, Siemens NX and Dassault SolidWorks) or boundary representation solid modelling (on platforms such as, by way of non-limiting example, Dassault CATIA and Autodesk Inventor). This is an essential ingredient in the formulation of a CAD-agnostic core algorithm powering the instant innovation.

In an embodiment, the algorithm of the instant innovation analyzes each sub-assembly of components in the context of the main tool assembly. In addition, the sub-assembly data consists of the mounting planes data for every component relative to its neighbors. A hierarchy tree is built based on this information, starting from the first component in the sub-assembly mounting on the main assembly and spanning all branches in the sub-assembly. This part of the algorithm uses time-efficient optimization methods to build the tree as well as to identify disconnected components that may be due to modelling errors. Based on the mounting information with neighbors and hierarchical labels, datum faces are determined for each component and relational start faces that are needed to dimension pertinent features. The sub-assembly level analysis concludes with the determination of primary drawing view orientation, in which datum surfaces are necessarily captured and important feature dimensions are aligned with the local coordinate system of the component.

In a principal embodiment of the instant innovation, at the heart of the core algorithm is the ability to recognize various functionally-significant design features and classify them based on their manufacturing intent. To accommodate for varying interpretation of features in different domain applications, this part of the algorithm involves a combination of logical flows based on geometric signatures specific to such features and attributes assigned on the 3D model. The logical flows are designed to analyze the given component in various orthographic and auxiliary perspectives relative to a primary orientation. Point group rotations about preferred axes are envisaged and applied on the geometric data for perspective-wise analysis. Auxiliary perspectives additionally require identification of relevant features in non-standard planes, their attribute signatures and formulation of a local coordinate system to dimension their features. Altered counterparts of standard components have a combination of dimensionable and non-dimensionable features. In this context “dimensionable” refers to the characteristic of a thing to have its physical dimensions determined and associated with that thing. An exact shape and geometry comparison of the raw and altered models is carried out to identify dimensionable features in the latter.

In an embodiment, each feature could be associated with one or more surfaces on the component. In the latter scenario, topological considerations specific to the feature in question are additionally envisaged in the algorithm design. In general, every surface is analyzed in its own right as well as in a larger topological context. This inclusive approach to feature recognition makes the algorithm easily adaptable and configurable to new designs and applications.

In an embodiment, and in addition to the deterministic logic, the core algorithm is augmented with heuristic pattern match algorithms backed by machine learning. In this novel process, topological motifs comprising one or more features are auto-generated from processed component drawings and interpreted as graph patterns. The dimensioning information is inferred along with the auto-generated features. Such data is continuously collected over an ever-growing repository of component assemblies. A heuristic model learning from this dataset recognizes patterns in a production environment and complements the feature determination process in the core algorithm. The learning models are envisaged to cover a wide variety of components in diverse assembly environments. This add-on paves the way for faster improvements in feature recognition process in broader domains and quicker adaption of the instant innovation to the manufacturing preparation process.

In an embodiment, each feature is associated with corresponding dimension entities as dictated by the domain and CAD configuration. Any redundant dimensions within or across the views are identified. For repetitive dimensions in the same view, appropriate append texts are calculated and associated. Additional domain specific texts are also associated with dimensions, such as those originating from a datum plane and a machining start plane. Hole callout specific start planes are associated with datum flag entities. After recognizing and classifying all dimension entities in all perspectives, an appropriateness comparison is made to select the views that suitably showcase the features properly aligned with in-plane directions. Priority is given to views which are aligned with machining operation or burnout direction or preferred profile orientation. These priority views ensure higher coverage of dimensionable features and indexable hole representations per view.

In an embodiment, the minimal number of views to display all required dimension entities are ascertained from the previous stage of the algorithm. In each such view, suitable drawing zone space is allocated around the view to place the dimension entities. The style factors and spatial extents associated with the dimension entities are taken into account to calculate the spacing around the view. This bestows every view with two zones—a scalable one bounding the actual profile of the component and a non-scalable part pertaining to dimension entities around the view. A sheet allocation algorithm is then envisaged to capture the selected projections with an optimal scale and minimum number of drawing sheets. The size and configuration of a drawing sheet are pre-determined by the component size and domain requirements. The configuration involves allocating space for fixed text and table callouts in different corners of the sheet. The algorithm makes room for variable requirements originating from different domains and allows for the dynamic calculation of usable space to place the views.

In an embodiment, within the usable space, projection views are placed with sufficient spacing to maintain their relative positioning. Scale ratios to be used for different view types are part of domain requirements. Using suitable scale ratios and recursive block placement algorithms, optimal allocation is determined that maintains the view ordering, maximizes the scale, as well as minimizes the number of sheets used on the element to be machined as a whole. For view types where view ordering is not important, the algorithm optimizes the number of sheets alone commensurate with minimizing scale requirement. The block placement algorithm is generalized to work for variable sheet sizes, configurations and view scales.

In an embodiment, holes to be indexed on different views are classified based on the parent view, hole type, hole size and other geometric details. The classification criteria are designed to be commensurate with the hole manufacturing intent. To sequence a class of holes that are spatially distributed over the extent of the component, a combinatorial optimization algorithm is envisaged to minimize the distance cost of traversing through the entirety of the set of holes to be machined. This algorithm is designed to handle limiting cases as well where time complexity grows exponentially. In cases where time complexity growth becomes a concern, heuristic clustering methods are used to reduce the complexity while simultaneously optimizing the overall distance cost.

In an embodiment, the sequenced holes and the manufacturing details associated with the sequenced holes are displayed in a common hole chart along with the respective distances in a local coordinate system of the component. The distances are calculated relative to planes of datum flags in each view. Direction labels and numerical precision to be displayed on the hole chart are customized as per domain requirements.

In an embodiment, labelling algorithms are used to calculate optimal positions for placing dimensional entities associated with a view. The rules embedded in this algorithm are (i) no overlaps of a label with other labels or graphical features of the drawing, (ii) each label can be identified with its parent feature in the view, (iii) the label must be placed in an optimal position relative to others in the neighborhood so as to not violate rules (i) and (ii). Graphical features can be classified as point-like, edge-like, or a ‘curved area’ like. Based on the geometry of the graphical feature and domain requirements on the style of entities to be used, labelling spaces are identified around the view. Each label is envisaged in a location that is orderly and sufficiently spaced with respect to its counterparts in the same zone, giving overall semblance of an aesthetic placement. The font size and character spaces used to display dimension values and texts on a drawing sheet are part of the configuration requirements and the algorithm is designed to adapt to both font size and character space.

In an embodiment, the Core Algorithm is supported by different subsidiary algorithms at various stages of the instant innovation. Important among them are listed below:

| Use case | Algorithm |
|---|---|
| Instant innovation runtime | Statistical Modelling using |
| prediction based on past | Polynomial Regression |
| runtimes vs respective | |
| tools' data size | |
| Optimal distribution of | Variational Analysis and |
| tool data across available | Simultaneous Optimization |
| servers on cloud | algorithms |
| a. To identify sub-assemblies | Optimized Graph Traversal |
| in the main assembly | algorithms |
| b. To identify disconnected | |
| components in sub-assemblies | |
| c. To determine constraints | |
| in Weldment assemblies | |
| d. To identify sequence of | |
| bends in Bent Bracket and | |
| segment decomposition | |
| e. Tool analysis module | |
| a. Primary View for a component | Axis-aligned Bounding |
| b. Stock Size calculation | Box algorithms |
| for different shapes | |
| Visibility checks for geometric | Plane-based Sampling for |
| entities in view | Ray Casting algorithms |
| SubDetail View placement | 2D Bins Level Packing |
| on drawing sheet | algorithms |
| Phantom Lines creation around | Geometric Curve fitting |
| curved edges at stock boundary | algorithms |
| of a component | |
| Identification of Slots and | Topological pattern match |
| higher dimensional features | algorithms |
| a. Relation between Tool and | Point group Orthogonal |
| Component Coordinate systems | Transformations |
| b. Auxiliary view orientation | |
| To calculate datum faces and | Simultaneous Optimization |
| start faces for a component | algorithms |
| Property based querying on | Data Binning algorithms |
| faces, edges on a component | |

In an embodiment, the instant innovation performs dedicated Gap and Interference-based 3D model checks on the Main Assembly and sub-assembly of each component and generates an interactive exception report to alert the end-user. Fixing these errors is critical for a proper assembly build and for generating the correct part drawings. The application interacts with CAD APIs and does space analysis using proprietary mathematical algorithms on the 3D model to generate this report. The application performs a clash analysis on the entire assembly to identify parts that are in the vicinity of each part being examined by the clash analysis algorithm and then builds a part attachment graph to determine the Solitary (a single part hanging in the air) and Disconnected Parts (a group of parts connected among themselves but disconnected from the main assembly) for each component sub-assembly. This mathematical algorithm ensures that every connected node in the tree is traversed from the start node to the set of end nodes to determine the set of disconnected nodes within each component sub-assembly. The mathematical algorithm also calculates the amount of gap between each part being examined and those parts determined to be within the vicinity of the part being examined and includes this information in the interactive report.

In an embodiment, the instant innovation recognizes Holes and Slots based on Vectra proprietary feature recognition-based Algorithms that utilize Geometry connections and performs different 3D Assembly based Hole and Slot analyses (such as, but not limited to, Hole Alignment Check, Correct Mating-Hole Check, Hole Diameter Check, Slot Clearance Check, Slot-Hole Alignment Check, Missing Mating-Hole check, as well as other verification checks performed during the 3D Assembly analysis). The Algorithm mainly involves the following steps regarding Pre-Processing, Hole-Slot recognition, and analysis of Holes and Slots.

In an embodiment, the instant innovation automatically recognizes the Various types of Holes and Slots from Feature and Non-Feature (dumb-solid) based CAD models. Following are the main steps involved in this recognition algorithm:

Pre-Processing
Reading the main assembly and sub-assembly charts and descriptions and recognizing the different Part Types (Manufactured Part, Standard Part, etc)
Engage one or more CAD APIs to perform Clash Analysis to find Vicinity touching parts and find the mating faces using the proprietary Binning Algorithm as previously referenced. In this embodiment, the Binning Algorithm deals with Binning Faces based on their Face Normals and then performing a mathematical check to determine the touching faces.

Hole and Slot Feature recognition
Cycle through all the faces (Cylindrical, Conical, spherical, planar) of all the solid bodies in the part
Holes and Slot recognition:

A Hole begins and ends in a Planar (most common) or Curved Face (rare). All subsequent faces in between, which are part of the Hole Feature, share a common axis which is designated and referenced as the Hole-Axis. All faces of a hole are sequentially adjacent to one another. A Hole terminates with a different bottom topology from the top- or beginning-hole topology.

The proprietary mathematical Algorithm of the instant innovation makes use of this Topology and Geometry information to recognize the Hole Feature. Similarly, for a Rectangular Slot, the system recognizes a pair of Anti-Parallel Planar Faces that would have a common Cylindrical Face. Geometry and topology-based algorithms handle hole end types including but not limited to frustum of cone, conical, spherical, and planer. Common hole types accommodated include but are not limited to thru, blind, ream, countersink, counterbore and spotface.

Hole And Slot Analysis and Check
Hole Analysis—these steps are performed to determine that the hole will be manufactured and placed correctly for the part to be machined:
1. Hole-Hole Alignment Check
2. Hole-Hole Drill Diameter Check
3. Hole-Correct Mating-Hole Type Check
4. No Mating-Hole Condition Check.
Slot Analysis—these steps are performed to determine that a slot will be manufactured, dimensioned, and placed correctly for the part to be machined:
1. Hole-Slot Alignment Check
2. Hole-Slot Correct Diameter and Clearance check
3. Correct Hole-Slot Combination Check
4. No Mating-Hole to Slot Check

In an embodiment, at the end of application execution, the instant innovation may generate one or more reports for the Hole and Slot Analysis.

In an embodiment, the instant innovation automatically identifies Hole(s) in each manufactured part and computes the Hole Type (by way of non-limiting example, Dowel, Clearance, Thread/Tap, CounterBore, CounterSink, or other holes types as required by the part to be manufactured) based on the Hole Geometry, Hole Drill Diameter, and Mating Hole Type. An innovation-specific property is added to each hole to enable the population of the Hole Chart or Drilling Chart in the 2D manufacturing or drilling plan based on the Hole-Type. The Hole chart enables the optimal drill machining time for the Holes. Correct identification of Holes is also crucial to defining the Datums (Datum-Hole) providing hole dimension, hole placement, and hole connectivity from which all 2D dimensions are referenced and which then enables the creation of correct manufacturing drawings.

The instant innovation interacts with CAD APIs and does feature analysis using proprietary mathematical feature-based algorithms on the 3D model to automatically identify the Hole Geometry, measure the Hole Drill Diameter and the hole relative position in the context of the assembly. This is a batch application that analyzes the entire assembly in one analytical step and calculates and applies the Hole Size attribute values to all the required Hole cylindrical faces

In an embodiment, the instant innovation starts with reading all the faces and edges associated with the part and classifying the faces (such as, by way of non-limiting example, Planar, Cylindrical, Conical, etc.) and edges (such as, by way of non-limiting example, linear, circular, elliptical, etc.). It also calculates the adjacent faces and creates a feature connection graph utilizing a proprietary algorithm from the top portion to the bottom portion of the Hole feature to determine the Hole Type. Additional logic is implemented to compute and identify the mating hole type to correctly assess the Hole being analyzed, since a thru type Dowel, Tap, and Clearance hole will all have the same geometry. Additional Diameter-based logic is used as a tie-breaker. All common and possible hole types are present as part of an XML-based config file. The instant innovation also identifies mixed hole types as one hole can end up intersecting with another hole due to the manufacturing needs of the part.

In an embodiment, the instant innovation determines all the faces in a part body that would require a Surface Finish. Different types of machining, such as, in non-limiting examples, fine and coarse, values are applied to these identified faces. The instant innovation automatically identifies all machined face(s) for each manufactured part in the main Tool Assembly. Identifying the correct machined face(s) is crucial to the correct build and optimal mating in the assembly. All mounting faces must be correctly machined to the correct precision for a perfect fit. This is a batch application process that analyzes the entire assembly in one shot and calculates and applies the Finish Tolerance value to all the required faces, which is a necessary input for Auto2D Algorithms.

In an embodiment, the instant innovation begins with identifying parts in the assembly that are in the vicinity of each part being examined by the identity analysis algorithm and uses a ray-casting algorithm to identify the mating faces for each pair of mating parts. A ray is transmitted from one part to the other and hit faces are determined, where hit faces are those faces that may “mate” or come into contact along the ray transmitted. Additional validation checks are performed to ensure that the mating faces' normal direction is anti-parallel. Faces must be antiparallel to each other for proper mating. One of the key inputs for identifying if the mating face will require a surface finish is to check for the presence of precision mating holes. Proprietary Geometry connection-based algorithms are used to identify hole features on the face and, using custom logic, the application determines if there is a precision mating hole in another part face to this hole on the mating face.

In an embodiment, the instant innovation also checks for the part material and custom logic is implemented for certain materials. In a non-limiting example, in the case of Aluminum, the mating faces along the thickness direction of the part are identified and ignored for assigning a Surface Finish. The instant innovation interacts with CAD APIs and customized Algorithms to automatically identify the machined faces and calculate and apply the correct machine tolerance in the context of the assembly. For each mating face with a required Surface Finish, the application also identifies the manufacturing operation that is used to machine the face, where machining requires removing material from the part. If there is a milling operation, it identifies the perpendicular face or wall that is associated with the milling cutter face and applies the correct Finish Tolerance. For this purpose, concave adjacent faces and features are identified using a customized mathematical logic process. These faces get a coarse machining tolerance instead of a finish machining tolerance.

In an embodiment, the instant innovation automatically computes the Stock Size value for each manufactured part in the Tool Assembly based on the physical material and the analysis of a proprietary shape and orientation algorithm. The computed stock value must match an available stock that can be purchased from the market. The batch application analyzes the entire assembly in one analytical step and calculates the Stock size value for each part factoring in the available stock and the correct part extents. The application interacts with CAD APIs and does feature and space analysis using proprietary mathematical feature-based and space-based algorithms on the 3D model to automatically compute the stock material and dimensions. The Stock Size value needs to be populated as part of the Stock Table in the 2D manufacturing list. The Stock Size value for the different parts depends on the following criteria: Shape, Surface Finish, Material and Geometry.

In an embodiment, parts can be of different Shapes like Flat, Round, Tubing, Angle, or other customized shapes as available in the market. For each of these shapes, a specific proprietary algorithm is used to compute the Stock. The application also computes the optimal part orientation along which the part needs to be oriented before computing the part extents or the part bounding area. Any material removed while doing a Surface Finish operation needs to be virtually added and considered as part of the Stock Size calculations. The Stock is added mathematically considering the different types of machining allowance and also based on the maximum part extent. Material plays an important role in mapping the calculated stock to available stock. The application uses a proprietary algorithm to ensure that there is minimal material wastage while calculating the required Stock Size.

There are special parts like Bent Brackets, which is a Flat piece of metal bent along one or more axes, for which additional customized algorithms have been created for analysis of such special parts. In an embodiment, the application of the instant innovation uses proprietary feature recognition-based algorithms to calculate the number of bends in a special part such as a Bent Bracket. The proprietary algorithm may then calculate the stock size value by mathematically unbending the part in each direction. A special part such as a Bent Brackets may have a geometry similar to an Angle Bracket and a specific geometry-based algorithm is used to distinguish between a special Bent Bracket part and a standard Angle Bracket part.

In an embodiment, each Customer may use a specific manufacturer-provided Stock Table. The Stock Table has different sheets based on the Shape-Material combination. The Stock is computed for each Solid Body in the Part. Each Solid Body can be made up of a different material. The application also creates a detailed report to list the parts for which the Stock Size couldn't be calculated due to geometry inconsistency or the absence of the Stock Table.

In an embodiment, the instant innovation utilizes a Part and Assembly Sweep Data Module operative to extract Topology and Geometry information from Part and Assembly information using CAD APIs across multiple CAD packages. The application can distinguish between a manufactured part and a commercially available part based on part metadata and customer data. The Main Assembly and Sub-Assembly Structure varies from one customer to another and the instant innovation created a custom configuration file to handle this variation by making use of Regular Expressions and Depth of the Part in the Assembly Tree to correctly assess the Part Type in the Assembly. For each manufactured part, the application reads all the solid bodies that make up the part and the different faces and edges that make up each solid body. Precise information is collected for every single face (such as, by way of non-limiting example, face-type: planar, cylindrical, spherical, conical, face-normal or axis-direction, face-center, face-curvature: concave or convex, and other face properties).

In an embodiment, for specific types of faces, unique properties associated with the face are also extracted, such as, in a non-limiting example, Half Angle information in case of a conical face, as well as the extraction of unique properties for other specific faces. The application also recognizes features, such as holes, slots, milling cutter perpendicular wall face, and machined faces, from a dumb solid, which provides no defined features in the feature tree, using custom and proprietary Geometry connection-based Algorithms. Dumb Solid(s) make the 3D model lighter and are preferable by various customers in the CAD space for their ease of use and for making any modifications or revisions. The application also builds up a face connection graph and identifies and reports connected and adjacent faces to form the complete solid to create the mathematical model for the part. Precise view orientations and rotation matrices are computed for each solid body using the collected face information that forms the base of computing the correct 2D view orientations, such that all required dimensions are possible to be shown in the Drawing Views. The instant innovation is able to successfully extract the topology and geometry information from the most popular CAD kernels in use by the different CAD Packages, such as B-Rep and Parasolid.

In an embodiment, precise mating/touching parts in each assembly and sub-assembly are also computed using custom Ray-Casting/Ray-Tracing-based graphics algorithms to identify the hit faces and by making use of facet data. This analysis helps form an assembly connection graph from the part in the assembly that is connected to another assembly all the way up to the part that connects to the automotive product which is handled by this assembly. The data from this analysis in its entirety is populated to an Excel database using OpenXML based EPPlus library, which speeds up the data writing process. A major portion of the Auto2D process of the instant innovation is performed using the customer environment with CAD package with minimal human interface. The entire Auto2D process can take an average of 7 to 8 hours for the complete end-to-end Drawing generation process to be performed. The Auto2D can be broadly divided into three stages, Data Extraction performed within the Customer Environment, Algo Processing performed within a Cloud Environment, and Drawing generation, which is also performed within the Customer Environment.

In an embodiment, Topology and Geometry Data is extracted on the customer environment from the Parts and Assembly in the first stage of the Auto2D process. The extracted data are stored in Excel Database files. The data files describing each manufactured part and assembly are maintained within an Excel Database file that is unique to that manufactured part and/or assembly. The extracted data from the customer environment is sent to the Cloud environment for Algo Processing. The Algo Processed data creates additional Excel files that are transferred back to the customer environment for the third and final stage of the Drawing Creation process. Once the Drawing is created for all the required parts, all the data (3D+2D) from the end-user system is pushed to a dedicated system for quality assurance review by one or more human analysts. The majority of the data transfer within the customer network makes use of Windows shared folders and automated Robocopy based Windows batch scripts.

In an embodiment, the automatic Data Transfer from the Customer Environment to the Cloud environment and vice-versa is being performed using Secured File Transfer Protocol (SFTP) with data encryption at source and destination. File Transfer may be through Batch and Powershell Scripts and through Windows Service.

Various Data Transfer Processes are Listed Below:
1. Extracted data from the end-user system to the Vectra Customer Gateway system (VCGS)
m. Extracted Data from the VGCS to Vectra Cloud
n. Processed Data from the Vectra Cloud to VGCS
o. Processed Data from the VGCS to the end-user system
p. Final Data from the end-user system to the Quality Check systems

In an embodiment, the application automatically generates Engineering Drawings for various Manufacturing Parts and Assemblies using CAD APIs across multiple CAD packages. The main input for this drawing creation is the Excel Database which is generated from one or more proprietary algorithms. These custom algorithms compute and generate the information for each Part and Assembly. This application automatically creates the following entities:
1. Drawing File and Drawing Sheet.
2. Drawing Template
3. Title Block Information
4. Views and Dimension
5. Hole Chart and Slot Chart
6. Customer Specific Notes and Stamps
7. Isometric View
8. PDF and Neutral format files

The application starts with automatically identifying the 3D part or Manufacturing part and assembly for which the drawings are to be created. Based on pre-established customer drawing standards, the application chooses the appropriate drawing file from the customer-provided Drawing file collection or creates a new drawing file for the individual part or assembly. All required Drawing Sheets in the drawing file are also created in this process. The correct Sheet size is determined based on the Algorithm provided information. Proper naming conventions for the drawing sheets and the drawing files are also created based on the customer specifications.

In an embodiment, the correct customer Drawing template is important to be added to every Drawing that is created by this module. Vectra has an XML-based configuration file to handle this change for multiple customers. The correct Drawing template for the specific customer is picked from this configuration file. The customer template that is added on every drawing sheet has an empty Title Block at the lower-left corner of the sheet. The information on the Title Block for each part and assembly is also filled automatically with this application. The Title Block information for each manufacturing part and assembly is either retrieved from the Part metadata or from the attributes that are created during the execution of the Vectra Pre Process modules. The application also creates the information in a dynamic manner using CAD APIs such that the information is always linked to some 3D metadata and gets automatically updated if the data changes to keep it always current and relevant.

In an embodiment, the application creates custom-oriented 2D view representations using CAD APIs for each part and assembly and adds them to the correct drawing sheet. The orientation, location, and scale information for each of these custom views are present in the Excel Database created by the one or more customized and proprietary Algorithms. The application also creates various types of dimensions such as Linear, Ordinate, Radial, Diametral Dimensions, etc., for each part and assembly with the customer-specific dimension settings and preferences. The choice of dimension is mainly based on pre-established customer standards. In addition to the dimensions, other entities such as Datum Flags, Specific Symbols, GD&T, Notes, Annotations, etc are also created by this application. The basic information to create all the dimension entities is transmitted from the Excel Database associated with that particular assembly and/or part. This application is also able to adopt the different drawing customer standards using custom XML-based configuration files.

In an embodiment, all the holes present in the part and the assembly need to be called out in the Hole Chart or Boring Chart, in the drawing sheet. The Part can have different types of holes such as Dowel, Tap or Threaded, Clearance, Counterbore, Countersink, etc. All these different hole types are sequentially indexed using a proprietary algorithm that is based on minimizing the machining and drilling time by drilling similar types of proximity holes which are determined based on the Hole type and the associated Drawing View. Hole center marks and the Hole Axis lines are also created on each view using the CAD APIs.

In an embodiment, all the manufacturing parts and assemblies will have some specific Notes and Stamps that need to be placed on the drawing sheet. These Notes and Stamps provide more information to the manufacturing team on the Process of operation, Tolerance used, etc. These stamps vary for each customer and part type. The system utilizes an Excel-based configuration file that enables the placing of the notes and stamps at the correct location in the Drawing Sheet.

In an embodiment, the isometric views are created on the drawing sheets for each part for a visual representation of the 3D assembly or part on a 2D space. The Orientation and the location for this isometric view are computed using proprietary algorithms. The application also generates a PDF file for each part and assembly at the end of the drawing creation process. In addition to the PDF file, some customers require drawing files in a neutral file format such as IGES, STP, DXF, etc for the downstream manufacturing processes. It automatically converts the drawing files into specific customer-needed neutral file formats and desired settings using the CAD APIs.

In an embodiment, this isometric view creation module creates the visual representation of three-dimensional Parts and Assembly in a two-dimensional workspace, which is configured as a manufacturing drawing sheet. The main functionality of this module can be briefly classified into:
1 Compute the isometric view orientation
2. Compute the available Drawing Sheet space to scale and place the created view

In an embodiment, the First Phase of this module is to compute the correct isometric view orientation of the Part and Assembly. Various Parts Types such as Manufacturing parts, multi-body parts, and Parts with sub-assemblies are currently handled by this module. All these Part Types are further broadly classified based on their Body Shapes (Flat, Angle, Tubings) and category of parts (Assembly Parts, Special parts). Listed below are the steps involved in computing the optimal isometric View orientation:
The Parts and Assembly of Parts are broadly classified based on their Shapes and Category
Based on the determined Shape and Category, a proprietary analytical process determines the Start Orientation of each part. The start orientation ensures that the part is upright, which is defined as the way the part will be mounted on the assembly.
From the Start Orientation, the Part is rotated to a configurable 30 degrees rotation about the drawing sheet in the X-direction, which is an orientation along the X axis.
Then the part is rotated again about the drawing sheet in the Y-direction, along the Y axis, in an increment of 15 degrees within a region of 0 to 360 degrees to complete the full circle.
For each interval of 15-degree rotation, certain parameters such as number of visible edges, number of visible faces, number of visible bodies, the maximum area occupied by the view are computed.
Together the computed parameters assist in determining the Optimal Orientation of the part.
This Optimal Orientation is the final desired Isometric view orientation for the part.
The computed Isometric view will have the maximum visible entities in this orientation to perform any downstream applications like calling out the individual bodies for final assembly and BOM (bill of materials)

In an embodiment, the second phase of this analytical process is to compute the available space on the Drawing Sheet. The Drawing sheet has some existing Base Views, Projected Views with dimensions, Customer Title block information, Hole Table, Revision Table, etc. This analytical process considers the presence of all these existing items and computes all the available blocks of spaces on the Drawing Sheet. Among the identified blocks of available space, the analytical process determines the optimal block of space such that the isometric view can be scaled optimally and placed.

This application deals with the creation of balloon callouts for all the subparts that are present in the Assembly and Welded Parts. These callouts are created using the CAD APIs across multiple CAD Packages. Some of the key aspects of this application are:
1. Identification of the visible peripheral Edge to create the callout
2. Avoid and eliminate any intersecting/crisscrossed callouts
3. Allocate different Drawing zones (Top, Bottom, Left, and Right) to the callouts based on view orientation and space availability

In an embodiment, one of the key challenges is to identify the most optimal visible peripheral edge on the subpart for attaching the callouts. The application uses CAD APIs to determine the subpart visible edges and also to compute the section of the visible edge (an entire edge may not be visible fully and may be broken into sections due to overlapping edges) by converting the edge into a parametric curve. In addition, a Vectra proprietary mathematical algorithm determines all the peripheral visible edges to the imaginary view boundary. The application also identifies parts that are not visible in the assembly and renders such parts in hidden lines to enable calling them out in the assembly.

Different parts in the assembly are called out in different zones (Top, Bottom, Left, and Right) to make the best use of the available Drawing space. A proprietary algorithm classifies each part into a specific zone depending on the nearness to the imaginary view boundary. When the number of callouts in a particular zone exceeds the threshold, the callouts are pushed and accommodated in the next zone of the same view in an anti-clockwise manner. The Zone allocation is in the order of Right, Top, Left, and Bottom. Callouts created may either be represented in numerical or alphabetical order based on the customer specifications. A custom algorithm also positions all the callouts in a zone along an imaginary view margin to improve readability.

The Callouts are created in such a manner that the criss-cross between the callouts is eliminated to the maximum possible extent using a mix of CAD APIs and mathematical algorithms. The application determines the intersection point between callouts using 2D line equations and resolves the criss-cross. Customer-specific drawing settings are also applied to each of the created callouts.

### Core Engine

The Core Engine is at the heart of Vectra's automated annotation and dimensioning software. Given below is the broad division of its computation modules and sequence of their operation. The computation workflow is parallelized over Parts making up the Tool assembly and the runtime environment is designed to scale up with the size of the assembly.
Data Engine→Inference Engine→Part Graph
Feature Determination Feature Prediction→View Selection
Dimension Location→Sheet Allocation
Hole Sequencing→Dimension Database

### Data Engine

In this document, the algorithm employed in each module, the facets of 3D model design and their algorithmic interpretation are described. Details of the programmatic implementation and application development methodology are excluded from the scope of this document.

### Types of Assemblies

Tools are modeled for a product line in a variety of assembly designs based on the domain of application. Some representative BIW Fixture tools are provided as examples in the following sections. Other domains of interest in Manufacturing Engineering are Powertrain Machining and Assembly, General Assembly, Sheet Metal Dies, Checking Fixtures, System Layouts.

On the design front Tools are generally architectured as a set of sub-assemblies called “Units”, each containing Parts assembled and constrained to operate together as a single unit.

Some Tools are modeled as a whole as one single functional Unit. In this case the whole Tool operates by itself as a highly constrained assembly of non-moving Parts.

Complex Tool assemblies are made up of a set of constrained functional units and moving parts. The constituent Parts are classified based on their functional nature and role played in constraining their neighbors in the assembly. A combination of such characteristic Parts makes up a functional Unit.

A Part by itself can be made up of one or more components of different shapes and sizes. A list of some generic shapes used in the BIW domain is—Flat, Angle, Rectangular Tubing, Round Tubing, Unistrut, Beam, Channel, Round. Parts consisting of multiple components are typically welded together and hence, called “Weldments”.

### Type of Data

The Core Engine essentially relies on the geometric data, assembly data and model level attributes assigned on the CAD models. The process of extracting this data is customarily designed using the APIs exposed by each CAD platform. Besides, the Tool architecture is analyzed based on the given assembly and the final dataset is presented in a standard format to the Core Engine program. This modular workflow makes the program immune to changes in the customer environment.

The geometric data consists of a point cloud of vertices wired together as edges bounding surfaces making up the model. In addition, the data also consists of curvature, directions and inflections associated with the surfaces. Using the geometric data the Core Engine reconstructs edge loops, face shells and the topology graph for the entire Part.

On the other hand, attribute data is a mix of model attributes assigned to the CAD objects and those inferred from the assembly and mapped to the algorithm parameters as per the client configuration. The data consists of component types, body shapes, material, stock size metric, class of standard counterparts, machining on faces, hole features, product contact faces, and so on.

Assembly data consists of a list of components in the Tool assembly, their aggregation in the form of unit and sub-unit assemblies, bodies in the component assemblies and mating information pertaining to them. More information on the design and assembly structure of Tools is provided in the next section.

### Data Correction

A 3D model designed either as a parametric solid model or using a boundary representation model is likely to be plagued with geometric inconsistencies arising out of incorrect modeling. Such inconsistencies can have a cascading effect on the Core Engine and its output. An independent correction algorithm is envisaged which operates on the raw CAD data and resolves known anomalies. In addition, coordinate data from irrelevant locations of the Tool assembly also creep into the input. Such outliers are identified by the correction algorithm and suppressed from being staged to the Core Engine. All the correction functions are designed based on the principles of vector algebra and topological constraints.

The attribute information is typically populated by the modeler, manually or using custom plug-ins. Its accuracy is crucial for the algorithm program to correctly recognize manufacturing features on the model. A machine-learning (ML) algorithm is additionally envisaged in order to predict some of the attributes and help designer error-check incorrect assignments. The ML augmentation is carried out through independent workflows and data pipelines prior to the data extraction stage.

### Data Interpretation

All the 3D entities in the model are identified by their application tags. The tags remain invariant across data extraction and drawing creation sessions which run at different points in time on the client workstation. Whereas, the algorithm program runs entirely on cloud with only endpoint communication with the client workstation. Hence, the algorithm's output is returned in the form of dimension annotations to 3D objects using the invariant tags.

The 3D coordinate data for all the Tool assembly constituents is fetched in a global coordinate system common to all components. In addition, the relationship with each Part's coordinate system (i.e., the one in which it is designed) is also extracted. Additional planes of interest to the Tool assembly (eg: Ground Plane, Support Platforms) are also extracted from the model.

The output of the Core Engine broadly consists of two parts: one that pertains to the 2D drawing views of each Part, another to the layout drawing views of the Tool assembly. In either case, the input 3D data is transformed from the component system and tool system respectively to the final 2D view systems of the respective drawings. The Core Engine computes the underlying transformations for every Part and sub-assembly in the Tool and returns them as output to the drawing creation program, in order to be interpreted and utilized to correctly orient the 2D drawing views.

### Inference Engine

The Inference Engine (IE) determines Principal Planes and Datum Features on a Part using the assembly information. The IE algorithm is described in the following sections.

### Assembly Tree

A Unit assembly is envisaged as a Tree Graph consisting of Parts as its Nodes and mounting between the Parts represented as Connection between respective Nodes.

A level hierarchy is built into the Tree starting from the First Part (FP) mounting onto the Frame or Base of the Tool. Using tree traversal algorithms, the shortest path to each node is determined from the FP. Distance is calculated in units of the number of connections required to reach the final node. The shortest distance to a node is assigned as its level in the hierarchy tree (HT) of the Unit. The HT levels are indicative of the assembly sequence in which Parts are mounted one on top of the other and is used later to determine Primary Plane of mounting for each Part.

A Unit assembly can consist of multiple sub-Units originating from their respective FPs mounted onto the Frame or Base. In this case, the HT will consist of two or more overlapping trees. The level assigned due to shortest distance HT takes precedence for an overlapping node. Its previous node(s) ascertained from the corresponding HT is (are) used in the later part of Primary Plane determination.

Parts such as screws, bushes are ignored during the tree traversal. They play only a passive role in the assembly and do not affect the final level computation. In the above Unit and its corresponding HT, screws are shown as fasteners for assembly.

The HT computation also identifies disconnected Parts or their sub-assemblies in the Unit. The disconnected Part clusters are either a result of modeling error or missing product files in the input Tool. Separate algorithm workflows are envisaged to analyze them.

In Non-Unitized Tools, the entire assembly is modeled as one single Unit, although there are functionally independent pseudo-Units mounted onto a common Frame or Base. The algorithm identifies FPs from the mounting Parts of the Frame and envisages HT for each pseudo-Unit assembly of Parts.

The IE algorithm is flexible to provide for customization of a tool assembly sequence. Apart from FPs, Unit assembly may contain one or more fixture components that act as fulcrum around which other Parts are mounted. In such cases, the HT trees are envisaged originating from respective start points and respective assembly sequence is determined.

### Principal Planes

Principal Planes are determined for each Part using the assembly sequence. For a Part with level N, all its mounting counterparts with level N-1 are identified from the assembly data. Preference is given to such Parts which are mounted via holes, especially ones that are precisely located. In absence of hole mounted Parts at N-1 level, ones at N, N+1 levels are also explored. In the priority order the connected Parts mounted via slots and/or cutouts come next.

The inference workflows are logically arranged to mimic the preferential mounting treatment employed in the Assembling stations.

### Datum Features

The Datum Features are anchors for the entire Part from where other features need to be referenced from and important functional features to be controlled during measurement. On a Part's drawing, Datums are placed along or about the Datum Features, in the form of flags, symbols, GD&T, etc. The measurement of important functional features is carried out from the Datums and along such axes of the Part about which most of the body mass is distributed, called as the local coordinate system (LCS) of the Part. The Principal Plane and Datum Features are ideally chosen to be along the direction of LCS axes.

When there are multiple mounting faces the one that is machined, containing mounting holes of preferred type and/or one with the largest area is preferred, as such a face offers more control in constraining the Part and precisely controls the dimension measurement. This Datum Feature is termed as “Datum Face”. This feature controls the dimensioning along the direction of its normal vector.

Similarly, among the mounting holes, precision holes followed by dowel holes are preferred over the other hole types, as they offer more control over the dimension measurement. This feature controls the dimensioning along the two directions orthogonal to its axis, and is termed as “Datum Hole”.

The choice of Datum Feature is clearly based on the measurement approach. In addition to or in place of the above strategy, other machined faces can also be selected depending on the Tool manufacturer. The Inference Engine is flexible to provide for configurational changes of this kind.

In the case of non-precision Parts (Eg.: Bent Bracket), which do need machining on any of its surfaces, non-precision holes and faces aligned with the LCS and mounted onto neighboring Parts are identified as potential Datum Features.

The mounting faces can be both planar as well as non-planar in Parts, such as Locating Pin. As a non-limiting example, a Locating Pin may be seated inside a Pin Retainer's cylindrical slot. The planar curved surface at the bottom of the Pin and the adjoining circumferential cylindrical face wrapping the Pin are mounted to the Pin Retainer. In this case both faces serve as Datum Features, where the planar one sets up dimensioning reference along the axial direction of the Pin and cylindrical face to locate concentric features in the orthogonal direction.

### Primary View

The Inference Engine utilizes Datum Features as a starting point to determine the Primary View to be displayed on the final 2D drawing. The Datum Face normal is envisaged to be the View normal, effectively turning the View to be parallel to the Principal Plane. The LCS directions orthogonal to the Datum Face are envisaged to be horizontal (H) and vertical (V) directions of the View. The LCS direction along which the Part extends longer is typically chosen to be the H direction, in compliance with the asymmetric aspect ratio of drawing sheets used for Layout drawings.

In some cases the Primary View is expected to mimic its orientation in the Unit assembly or the “standing view” in the Tool. This is typically the case of Riser Brackets, Frames, etc. As a non-limiting example, the Principal Plane and Datum Features of a Riser Bracket are on the bottom mounted face of the assembly. However, the Primary View is selected to be one where the Bracket's long axis appears vertical in the View. Selection of Parts that fall under this category may be customizable in the Inference Engine.

When the assembly is that of a Clamp Unit, such as one consisting of Power Clamp or Clamp Cylinder, the associated Blades, NC Mylars, Clamp Arms directly or closely mounted onto Clamping Parts are influenced by their mounting condition relative to the Clamping Parts. In such cases, the Primary View's V direction of the associated Parts is made to align with the longitudinal axis direction of the Clamping Parts. This is in line with the clamping force exerted on the rotational degrees of freedom of the associated Parts.

The primary goal of Primary View determination is to be able to capture all dimensionable features on the Part within one or more orthographic projections about the View. In the absence of any functional features that need referencing from Datum Features, potential datum features are utilized in the Primary View determination. Such as in the presence of non-precision features like cutouts on the Principal Plane of mounting. Besides, the orthographic projections must serve as a reference view to auxiliary planes containing dimensionable features, especially of machining kind.

### Auxiliary Views

There may be dimensionable Hole features (on Flat bodies) whose axes are not aligned with the overall LCS of the Weldment. In this case, the Frame's Primary View is determined to be standing orientation such that the floor mount plates remain seated at the bottom. Suitable orthographic projections about the Primary View lead to Auxiliary Planes in which the Hole features and their parent Flat bodies appear axis aligned.

The determination of orthographic projection leading to Auxiliary Views involves identifying the “reference hole” used to locate the Auxiliary Hole features. The projection containing the reference hole shares an angled edge interface with the Auxiliary Plane. This edge direction is used as an axis of rotation about which reference orthographic projection has to be rotated, until the Auxiliary Plane is aligned with the screen normal. The final view's LCS directions will be comprised of Auxiliary Plane normal, the direction of angled common edge and orthogonal direction to both. Features on this view are located along the new LCS directions.

Auxiliary Planes can constitute other types of features as well, such as slots, cutouts, which are otherwise not referenced along the Part LCS directions. As a non-limiting example, a segment of Bent Bracket containing the Slot feature requires an Auxiliary View to be envisaged. However, there is no reference hole in this case. The segment's plane normal and the common edge that it shares with standard orthographic projection may be used to envisage the Auxiliary View. The Slot faces are then referenced along the local axes of the segment.

### Ignored Parts in the HT

Following Parts are ignored as part of HT construction in BIW assembly fixtures. The list is representative and by no means exhaustive. Besides a custom list, the Inference Engine can also accommodate mounting scenarios either to ignore or to override preferences in constructing an HT for the Assembly.
“ANCHOR ANGLE”, “BEARING”, “BOLT”, “BUSH”, “CABLE”, “CAP HEAD”, “CHANGER”, “COVER”, “DEVICENET”, “DEVICE-NET”, “DEVICE NET”, “DOWEL”, “FASTENER”, “FASTNER”, “FLOOR LEVELING PLATE”, “FLOW CONTROL”, “GRID”, “HILTI TYPE ANCHORING SYSTEM”, “10 BLOCK”, “I/O BLOCK”, “MAGNET”, “MANIFOLD”, “NUT”, “OPEN POSITION”, “PROX”, “RECEPTACLE”, “ROBOT ADAPTER PLATE”, “SCREW”, “SECTION”, “SHCS”, “SLEEVE”, “SOCKET HEAD CAP SCREW”, “STUD”, “TAP BLOCK”, “TOOL CHANGER”, “VALVE”, “WASHER”.

### Part Graph

The Part Graph determination involves building topological connections between bodies, faces and edges on the given part and developing a toolkit of methods to determine various features on the Part. Using the geometric data of edges and face, the part graph is constructed of edge loops on each face, face shells enclosing a body and a tree of mate bodies making up the part. In addition, topological and geometric properties characterizing these 3D objects are envisaged, such as edge sharing faces, concentric faces, coplanar/orthogonal/anti-parallel counterparts, and so on. Furthermore, the local coordinate system (LCS) of the part is utilized to further characterize faces based on their relative alignment and positioning. As non-limiting examples, faces (mis-)aligned with LCS axes, peripheral faces along a given direction, and so on.

In addition to the geometric data, Data Engine also loads attribute data into the algorithm. The attribute data comprises machining information, hole size and feature information, pre-fabrication holes, construction holes, product contact faces, body shapes and material, tool class and so on. This information is further utilized to characterize the faces and bodies of the part graph. For instance, parts constituting bodies designed out of a standard counterpart, i.e. one of the same shape and standard stock sizes. In such cases, comparison of part graphs and axis-aligned characteristic face properties will help in determining “new faces” on the altered part.

Similarly, hole faces are characterized into different type classes depending on their hole feature attributes. Using the face adjacency matrix the planar counterparts to hole faces are identified, in order for appropriate view selection to be made subsequently for indexing the hole faces. The topological connections of holes, slotted holes, cutouts with their outer-plane faces are leveraged in dimensioning such features in their most descriptive perspectives.

### Feature Determination

Feature determination algorithm is at the heart of the Core Engine. It comprises a set of deterministic rules to identify dimensionable features on the part and respective start points to place dimensions to them. Orthographic and auxiliary views are envisaged to analyze the feature from different perspectives and the most descriptive views are eventually chosen to show dimensions to all features.

### Machine Start Faces

The locating dimensions to Datum Features are envisaged from Machining Start Faces (MCSF). These faces are typically rough faces situated on the periphery of the Part and aligned with the LCS axes. Larger surfaces among the potential ones are preferred to allow for better control over the temporarily named Machining Start dimension.

The preference of peripheral faces can be overridden when the Part itself is cut out from a Burnout profile, whence the peripheral faces turn out to be machined in general. Besides, the Datum Features are to be located sometimes from a so-called “First Machined Face” (FMF), which is characterized by fine machining tolerance. In this case, the FMF will be first located from MCSF followed by the Datum Feature in turn located by the FMF. The latter dimension is then referred to as the Machining Start dimension.

The choice of MCSF—DF pair or MCSF—FMF—DF triad is dictated by the proximity conditions. Such a pair or triad exists for each LCS direction of the Part in question. The proximity conditions are envisaged to minimize the overall/cumulative distance between them. The potential set of pairs or triads are constructed initially, made up of potential Datum Holes (or Datum Faces), potential MCSFs and FMFs. Distances between each pair or triad are computed along the respective directions, before setting up a series of minimization filters and arriving at the final pair or triad.

### Cut Start Faces

Cut Start Faces (CSF) are typically rough faces used to reference profile cut faces on the part. For easy referencing peripheral rough faces are generally chosen as CSFs. However, when the peripheral faces are machined, either due to machining operation or flame cut, their virtual counterparts are envisaged in the drawing view profile and considered to be CSFs in order to locate cut faces in the respective directions of the part.

### Fab Start Faces

Fab Start Faces (FSF) are determined for a weldment where bodies of one or more shapes are welded together into a part assembly. They are used to commonly reference structure forming bodies, such as rectangular (or square) tubings, unistruts, beams, as well as precision bodies. Similar bodies are picked for determination of FSFs for better control of referencing and measurement. Non-precision bodies are referenced from the local precision body on which they are mounted. When additional plane of bodies are present on a weldment aligned with non-LCS directions, their FSF are determined relative to the LCS aligned ones in their close proximity.

### Dimensionable Features

The dimensionable features are determined using a hierarchy of rules, first to identify simple features and then to override them if they are part of a bigger complex feature. As a non-limiting example, a simple cut face could be part of a slotted hole or that of a bend. In either case, the cut face is dimensioned from a local start point, instead of a CSF. In order to apply such superseding rules, known complex features are determined on the given part with the help of a combination of geometric and topological assertions. Such complex features include bends and local segments on a bent bracket, slotted holes of different geometries, chamfer and non-aligned cuts, auxiliary plane of holes, associated machined faces, indexable and locating holes, round bodies, and so on.

### Feature Prediction

Dimension Prediction using Deep Learning

A novel solution has been developed which is used to predict dimension callouts to be associated with a face of a 3D model. Dimension entities are predicted using a graph deep learning model with high accuracy. The dimensions may be placed in the 3D CAD model and/or 2D Engineering Drawings using other automated methods developed by Vectra.

### Deep Learning Workflow

To train the graph deep learning algorithm, 3D CAD models and associated drawings are collected. The 3D CAD models are converted into CAD agnostic part graphs by extracting geometric information from the 3D model using APIs that interface with various CAD packages. The part graphs are created by converting the face of the 3D model into a node of the graph, and the edge of the graph is created from shared edge information obtained from the 3D model. The geometric information of a face of the 3D model is stored as a node property of a part graph. The associated drawings are converted into labels for training. The entities associated with an edge are converted into labels associated with a face using view information. For training the graph deep learning algorithm, the part graphs are stacked to create a training adjacency matrix, similarly, the labels are stacked and prepared for training. Each entity is predicted independently and modelled as a binary node classification problem. The training data is converted into low-dimensional embeddings using the GRAPH SAGE algorithm and fed to a neural network. The neural network is a 2 layer-deep fully connected network which learns the relationship between a face and the dimension entities associated with it. Each dimension entity is modelled in a similar way using an independent deep learning model. The training process is inductive, hence, the trained model is stored and can be used to make predictions on new part graphs which were not part of the training adjacency matrix.

### Dataflow

Geometric information is collected from 3D CAD models by software running on CAD designer PCs, the training labels for each of the 3D CAD model is also generated on CAD designer PC. The geometric information and the labels are pushed to the AWS S3 repository. For training, the geometric information and labels stored in AWS S3 are sent into AWS Sage maker for training. The geometric data is converted into part graphs in AWS Sage maker for the training process. The trained model is stored as a pickle file on the AWS S3 once the training process is complete. The inference pipeline makes use of a trained model which is stored on AWS S3. For the inference pipeline, geometric data is extracted from the 3D CAD model and pushed to AWS S3. An inference engine running on AWS Sagemaker consumes the geometric data from AWS S3, converts it into a part graph and uses the trained model to predict the dimension entities to be associated with the face of the part. The inference results are stored on AWS S3. An AWS Lambda instance picks up this inference result and does post-processing on it to generate a Dimension Database. The Dimension Database created on the AWS Lambda is stored on AWS S3. Using a polling mechanism, the Dimension Database is sent back to the designer's PC. The drawing creation software uses this Dimension Database to create the 2D engineering drawing for the 3D CAD model.

### View Selection

The premise of View Selection is that the most descriptive views must be selected, in order to call out the dimensions and annotations on a given part. Such views include auxiliary projections about the orthographic projections about the primary view, section views, detailed views and so on.

A given dimensionable feature and its associated dimensions can be shown in one or more views. However, the validity of the dimension is determined by various factors. At the outset the dimension direction must be in the plane of view and its end points must be identifiable on the view. The pertinent faces must be non-occluded and their profile plane must be distinctly clear.

In the case of holes or slotted features, views aligned with their axes and projecting their machined, non-occluded ends are preferred. In the case of auxiliary holes, views distinctly displaying their folding line and construction hole (where it applies) are picked as reference views.

A feature is analyzed in multiple orthographic projections and the views with most potential dimensions, indexable holes and slots, are identified to be the potential views for drawing creation. Repeated dimensions are specified with a text or repetition index in the selected view and its copies are filtered, either in the same view or across the views.

### Dimension Placement

The Dimension Placement algorithm takes into consideration the dimensioning style for the given configuration and staggers the dimensions distinctly around each view. Dimensions are typically placed in two ways—inside the extension lines or outside of them. The extension lines should not cross dimension lines, object lines or other extension lines. For this reason the dimensions are staggered away from each other beyond the view. In the case of group dimensions or chain dimensions, the dimensions are placed in series, with the first dimension stuck to the base line.

Some configurations employ arrowless dimensioning style, where each of the dimensions are shown without arrowheads and they are referenced in each direction about the respective zero line.

The start features are generally chosen to be closer to one end of the view, so that dimensions of the view appear to be positioned from a common end, called baseline. This unidirectional dimensioning strategy is preferred by most configurations.

Angular dimensions indicate the angular position of a feature relative to a reference axis (either of the view object or the model object).

Some configurations prefer to show the dimension value in two units of scale (inch and mm for locating dimensions). In such cases, the two numerical values are placed above and below the dimension line, to the left or right, depending on the orientation of the dimension.

A given dimension can be accompanied by additional notes or tolerance values. Notes are generally placed in one of the top, bottom, left and right positions. Tolerances are placed to the right center aligned with respect to the main dimension value.

### Hole Sequencing

The Hole Sequencing algorithm attempts to sequence the holes in an order that minimizes the machine travel time across the parent part extents. The holes are initially classified depending on their type and size in each view and sequencing strategy is applied for each class of holes independently. This grouping is in line with the fact that machine drill heads are different for different classes of holes.

Slotted holes have to be considered as a pair in order to be indexed in succession or only once, depending on the configuration. Similarly, holes on section views and auxiliary views are grouped together into a class of their own.

An algorithm to minimize the overall distance cost for each class of holes is employed. This is referred to as “traveling salesman problem” in the standard literature. Since this is a NP-hard problem, approximate methods are used to implement the same in our problem context. When a class contains holes greater than a threshold value, the computational time blows up exponentially. In this case, clustering strategies are employed to sub-divide the group of holes using standard space-partitioning techniques. This hybrid approach allows our algorithm to scale for any number of holes in the part.

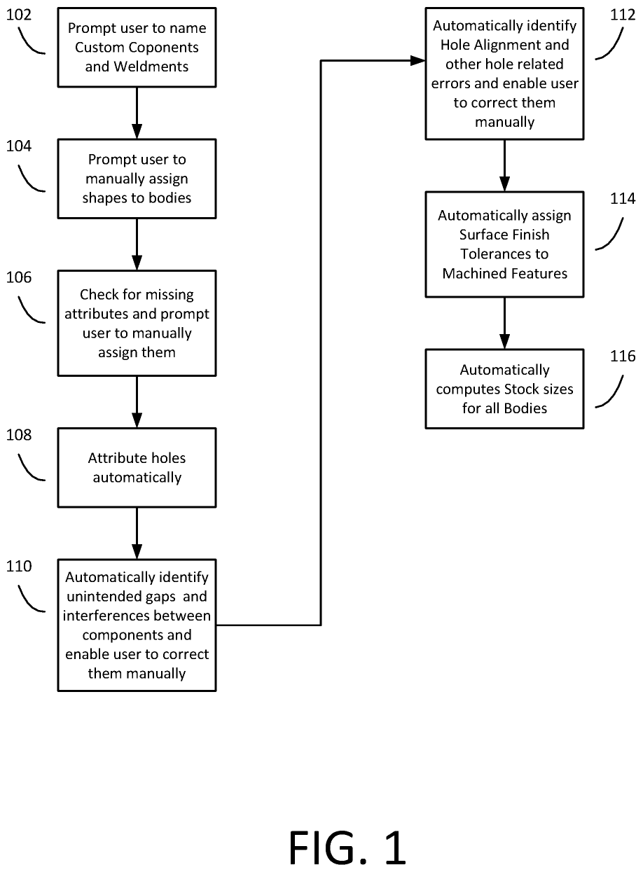

Turning now to FIG. 1, an overview of pre-process modules consistent with certain embodiments of the present invention is shown. At 102 a first process module prompts a user to name all Custom Components and Weldments present in the subject of a particular three-dimensional model. A second process module at 104 prompts the user to manually assign Shapes to Bodies. A third process module at 106 automatically checks for missing attributes and prompts the user to manually assign any attributes found to be missing. A fourth process module at 108 automatically attributes hole placements. A fifth process module at 110 automatically identifies any unintended gaps and/or interferences between components and enables the user to manually correct any gaps and/or interferences so identified. A sixth process module at 112 automatically identifies any Hole Alignment errors and/or other hole-related errors and enables the user to manually correct any errors so identified. A seventh process module at 114 automatically assigns Surface Finish Tolerances to Machined Features. Finally, an eighth process module at 116 automatically computes Machine Stock sizes for all Bodies.

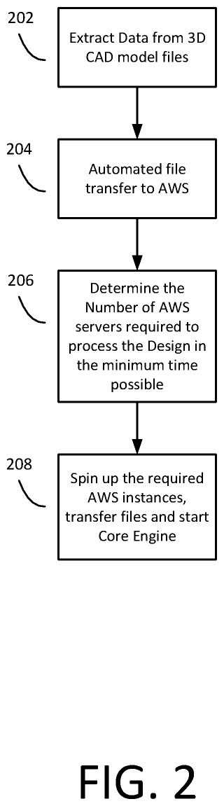

Turning now to FIG. 2, a view of a sub-process for 2D data extraction consistent with certain embodiments of the present invention is shown. At 202, the sub-process extracts data from a user-selected three-dimensional (3D) computer-aided drafting (CAD) model file. At 204, the sub-process performs automated file transfer to a shared server provider such as but not limited to Amazon Web Services (AWS). At 206, the sub-process determines the number of servers required to process the Design in the minimum time possible. At 208, the sub-process spins up the required server instances, transfers files, and starts the Core Engine.

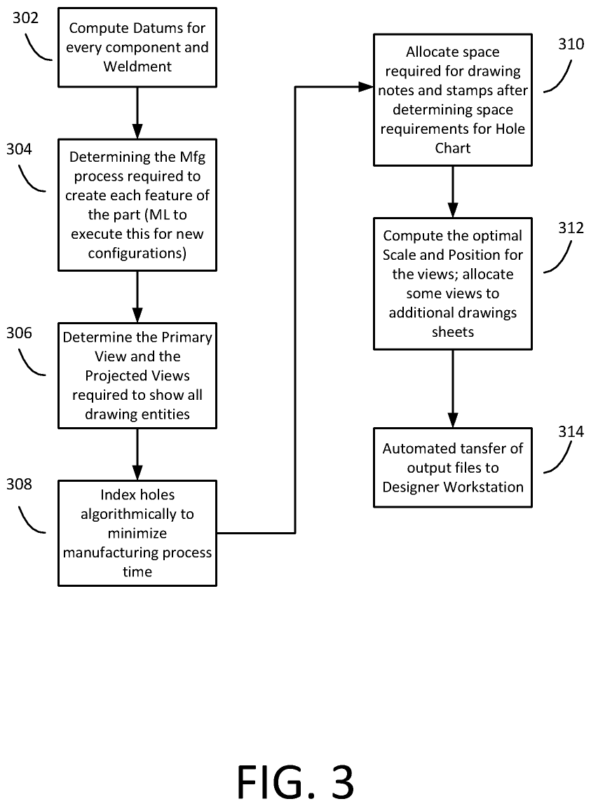

Turning now to FIG. 3, a view of a sub-process for core engine operation consistent with certain embodiments of the present invention is shown. At 302, the sub-process computes Datums for every Component and Weldment. At 304, the sub-process determines the manufacturing process required to create each feature of the part. The sub-process uses Machine Learning (ML) to execute this step for new configurations. In so doing, the sub-process use of ML predicts optimized processes for newly configured designs based at least in part upon sub-process historical experience. At 306, the sub-process automatically determines the Primary two-dimensional (2D) View and the Projected 2D Views required to show all drawing entities. At 308, the sub-process indexes holes algorithmically in order to minimize required manufacturing process time. At 310, the sub-process allocates the calculated space required for drawing notes and stamps after it has determined space requirements for a Hole Chart. At 312, the sub-process computes the optimal Scale and Position for all Views and if necessary or advisable allocates one or more views to one or more additional drawing sheets. At 314, the sub-process automatically transfers output files to a Designer Workstation.

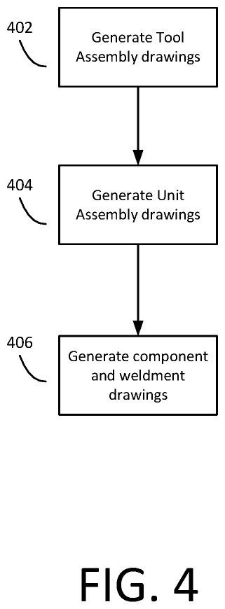

Turning now to FIG. 4, a view of a sub-process for automated 2D drawing generation consistent with certain embodiments of the present invention is shown. At 402 the sub-process generates Tool Assembly Drawings; at 404 the sub-process generates Unit Assembly Drawings; and at 406 the sub-process generates Component and Weldment Drawings.

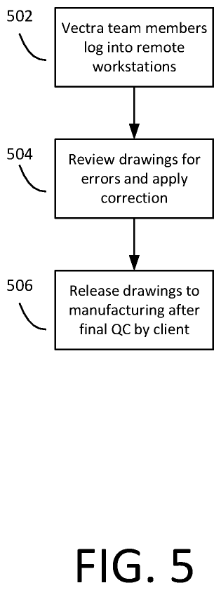

Turning now to FIG. 5, a view of a sub-process for 2D drawing quality control consistent with certain embodiments of the present invention is shown. At 502, the sub-process entails process-provider team members (by way of non-limiting example, Vectra team members) logging into remote workstations. At 504, the team members manually review drawings for any errors and apply appropriate correction. At 506, the team members release corrected drawings to the manufacturer only after the client has performed a final quality check (QC) of the corrected drawings.

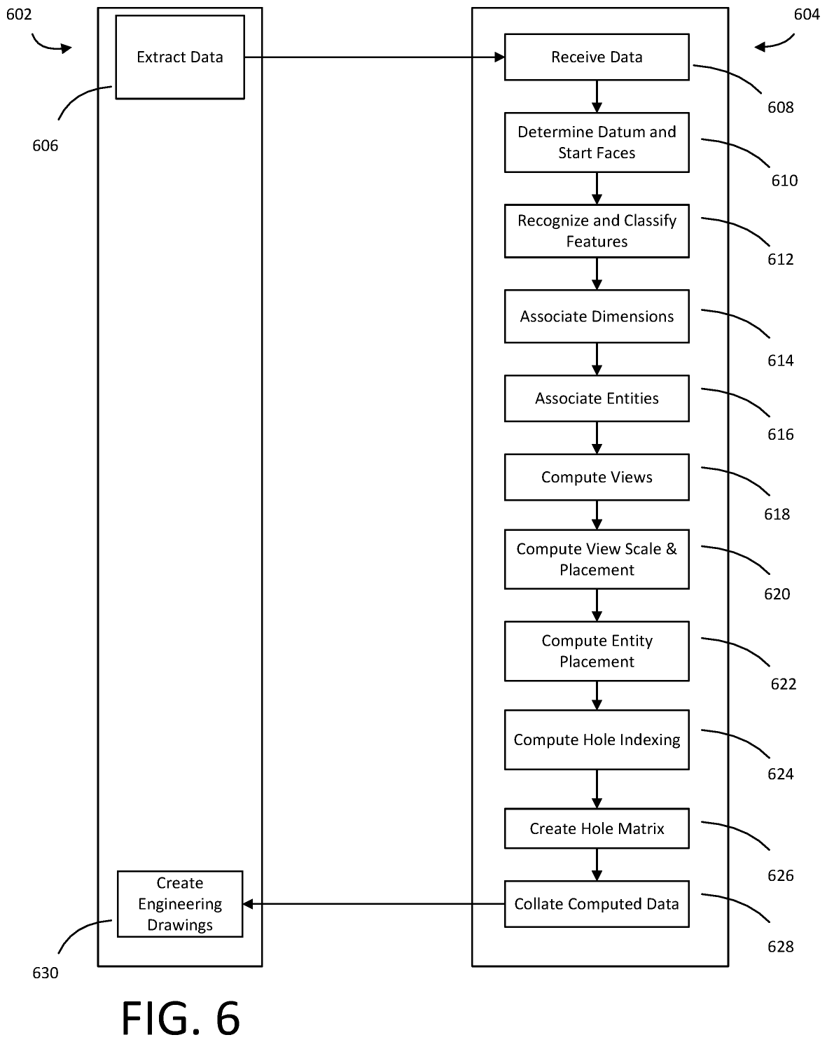

Turning now to FIG. 6, an overview of the data processing workflow consistent with certain embodiments of the present invention is shown. User interacts with the instant invention through CAD Workstation 602. At 606, the instant innovation extracts required manufactured part data from a 3D CAD model using the native CAD format; said part data is sent to Cloud-based server 604. At 608, the part data is received by the server and at 610, the instant innovation determines datum and start faces for common features based upon assembly-level analysis. At 612, the instant innovation recognizes and classifies the various manufactured features of the part. At 614, the instant innovation associates linear and ordinate dimensions between each feature and the relevant applicable datum location. At 616, the instant innovation associates to the various features applicable drawing entities such as, but not limited to, Datum Flags and Machining Symbols. At 618, the instant innovation computes various orthographic and auxiliary views required to illustrate all the drawing entities. At 620, the instant innovation computes the optimum view scale and placement of the various views on the drawing sheet. At 622, the instant innovation computes the placement of all drawing entities. For all holes present in the part, at 624, the instant innovation computes the optimum hole indexing sequence to minimize machining time. At 626, the instant innovation creates a hole matrix listing data including, but not necessarily limited to, applicable hole index number, spatial coordinates, hole type, and hole precision (such as, by way of non-limiting example, tolerances). At 628, the instant innovation collates all computed data, which is returned to the CAD Workstation 602. At 630, the instant innovation creates engineering drawings with features including, but not necessarily limited to, all required views, entities, and hole charts in the native CAD format.

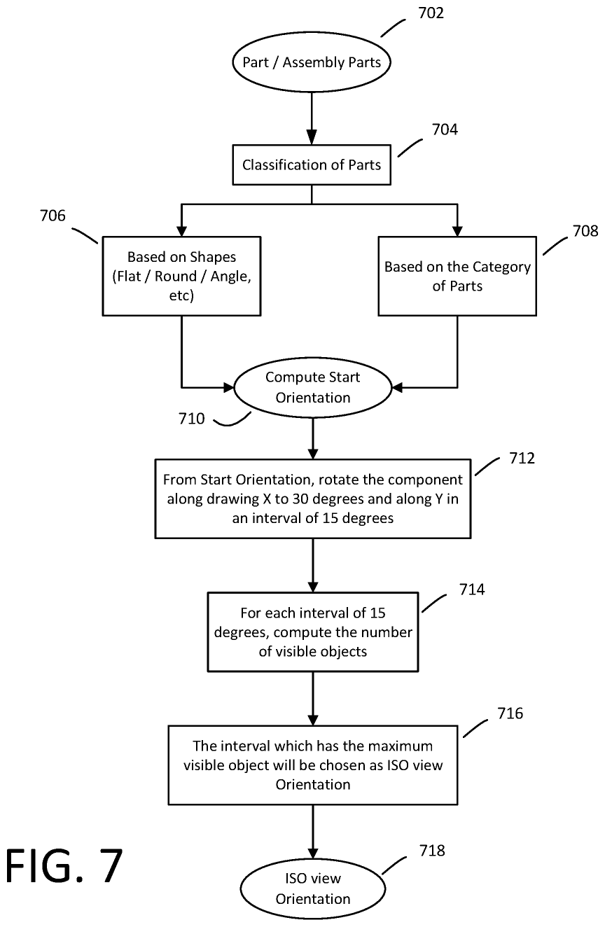

Turning now to FIG. 7, a process flow diagram for selection of isometric views consistent with certain embodiments of the present invention is shown. At 702 the system receives data regarding one or more parts or assembly parts and at 704 the system initiates classification of said parts or assembly parts. At 706 and 708 classification is based upon part shape and part category, respectively. At 710 the system computes a start orientation for the rotation of the component, when the component is a part or assembly part. At 712, the system rotates the component along drawing axis X to 30 degrees and along drawing axis Y in an interval of 15 degrees. At 714 the system computes the number of visible objects in the component for every interval of 15 degrees. At 716 the system determines which interval of the set of all intervals includes the maximum number of visible objects and selects data describing that interval to form the basis of the isometric view orientation. At 718 the system delivers to a user the isometric view.

While certain illustrative embodiments have been described, it is evident that many alternatives, modifications, permutations and variations will become apparent to those skilled in the art in light of the foregoing description.

What is claimed is:

1. A method for 3D engineering drawing extrapolation and automation comprising:
receiving a three-dimensional (3D) computer model of a part to be manufactured and breaking down the 3D model of the part into labelled surfaces capable of being attributed, assigned and represented by two-dimensional (2D) engineering drawings;
analyzing said 3D computer model by a machine learning algorithm to determine elements of labelled surfaces to be aligned;
analyzing the labelled surfaces to determine if there are unintended gaps, interferences, or other irregularities that interfere with said alignment;
creating a list of the unintended gaps, interferences, or other irregularities and presenting the list for human user review and correction;
receiving at said machine learning algorithm said list of human user review and corrections;
incorporating by said machine learning algorithm said corrections to produce updated 2D engineering drawings and creating one or more parts according to said updated 2D engineering drawings.

2. The method according to claim 1 where analyzing the labelled surfaces comprises extracting manufactured part data from a user-selected three-dimensional (3D) computer-aided drafting (CAD) model file using the native CAD format by user at CAD workstation;
sending manufactured part data to a cloud-based server bank;
determining the number of servers in the cloud-based server bank required to process the design in the minimum time possible;
initiating the required server instances;
transferring files to the servers;
processing the files using a core engine.

3. The method according to claim 1 where processing the files using a core engine comprises receiving manufactured part data by the cloud-based server;
determining the manufacturing process required to create each feature of the part;
determining datum and start faces for common features based upon assembly-level analysis;
recognizing and classifying the manufactured features of the part;
associating linear and ordinate dimensions between each feature and the relevant applicable datum location;
associating to the features applicable drawing entities;
computing orthographic and auxiliary views required to illustrate all the drawing entities;
computing the optimum view scale and placement of the views on the drawing sheet;
computing the placement of all drawing entities;
computing the optimum hole indexing sequence for all holes present in the part in order to minimize machining time;
creating a hole matrix listing data including;
collating all computed data;
returning all computed data to the CAD Workstation;
computing the optimal scale and position for all views;
creating engineering drawings with features at said CAD workstation.

4. The method according to claim 3 where determining the manufacturing process required to create each feature of the part comprises
using heuristic pattern-match algorithms and one or more machine learning algorithms to recognize one or more features and to auto-generate one or more parts from component drawings;
interpret as graph patterns motifs comprising one or more features and to infer dimensioning information for each of said one or more features.

5. The method according to claim 3 where computing orthographic and auxiliary views required to illustrate all the drawing entities comprises:
receiving data regarding one or more parts or assembly parts;
initiating classification of said parts or assembly parts based upon part shape and part category, respectively;
computing a start orientation for the rotation of the component, when the component is a part or assembly part;
rotating the component along drawing axis X to 30 degrees and along drawing axis Yin an interval of 15 degrees;
computing the number of visible objects in the component for every interval of 15 degrees;
determining which interval of the set of all intervals includes the maximum number of visible objects;
selecting data describing the interval that includes the maximum number of visible objects to form the basis of the isometric view orientation;
delivering to a user the isometric view.

6. The method according to claim 1 where human user review and correction comprises
process-provider team members logging into remote workstations;
process-provider team members manually reviewing 2D engineering drawings created by one or more of said machine learning algorithms for any errors and applying appropriate correction;
saving said correction to a database of components accessible to one or more machine learning algorithms for continued training of said machine learning algorithms;
process-provider team members releasing corrected drawings to the manufacturer after the client has performed a final quality check of the corrected drawings.

7. The method according to claim 1 further comprising pre-processing steps of
prompting user to label custom components and weldments present in the subject of a particular three-dimensional model;
prompting the user to manually assign shapes to bodies;
checking for missing attributes and prompting the user to manually assign any attributes found to be missing;
attributing hole placements;
identifying any unintended gaps and/or interferences between components and enabling the user to manually correct any gaps and/or interferences so identified;
identifying any hole alignment errors and/or other hole-related errors and enabling the user to manually correct any errors so identified;
assigning surface finish tolerances to machined features;
computing machine stock sizes for all bodies.

8. A system for 3D engineering drawing extrapolation and automation comprising:
a CAD workstation and a cloud-based server bank comprising one or more cloud-based servers;
where the CAD workstation is communicatively coupled to the cloud-based server bank;
where the CAD workstation is adapted to interact with a user;
where the one or more cloud-based servers comprise one or more processors in communication with one or more digital devices;
where the one or more cloud-based servers are operable to receive manufactured part data comprising labelled surfaces extracted from a user-selected three-dimensional (3D) computer-aided drafting (CAD) model file, analyze the labelled surfaces to determine if there are unintended gaps, interferences, or other irregularities, and to create a list of the unintended gaps, interferences, or other irregularities;
analyzing said 3D computer model by a machine learning algorithm to determine elements of labelled surfaces to be aligned;
where the list of the unintended gaps, interferences, or other irregularities is adapted to be presented to a human user for review and correction;
receiving at said machine learning algorithm said list of human user review and corrections;
incorporating by said machine learning algorithm said corrections to produce updated 2D engineering drawings and creating one or more parts according to said updated 2D engineering drawings.
